(19) United States
(12) Patent Application Publication
(10) Pub. No.: US 2026/0002739 A1
(43) Pub. Date: Jan. 1, 2026

(54) HEAT EXCHANGER MODULE, HEAT EXCHANGER SYSTEM AND METHOD FOR MANUFACTURING A HEAT EXCHANGER MODULE

(71) Applicant: UHRIG Energie GmbH, Geisingen (DE)

(72) Inventor: Thomas Uhrig, Geisingen (DE)

(73) Assignee: UHRIG Energie GmbH, Geisingen (DE)

(21) Appl. No.: 19/249,525

(22) Filed: Jun. 25, 2025

(30) Foreign Application Priority Data
Jun. 27, 2024 (DE) 10 2024 118 193.1

(51) Int. Cl. F28F 1/12; B23P 15/26

(52) U.S. Cl. CPC F28F 1/12; B23P 15/26

(57) ABSTRACT

A heat exchanger module for obtaining thermal energy from wastewater including a heat exchanger element inserted into a wastewater pipe allowing working fluid to flow, and a fluid line supplying or discharging the working fluid to or from the heat exchanger element. The heat exchanger element and the fluid line are fluidically connectable via a connection including a socket connected to the heat exchanger element, a through pipe connected to the fluid line and extending through a wall of the fluid line, and a screw element. The socket and screw element are threadedly engageable with each other through the through pipe so that a socket pressing surface is pressed onto a first through pipe pressing surface and a screw element pressing surface is pressed onto a second through pipe pressing surface to connect the heat exchanger element and the fluid line to each other in a fluid-tight manner.

### CROSS-REFERENCE TO RELATED APPLICATIONS

This application claims priority to German Patent Application No. DE 10 2024 118 193.1 filed on Jun. 27, 2024, the entire contents of which are incorporated herein by reference.

### BACKGROUND

The present disclosure relates to a heat exchanger module for obtaining thermal energy from wastewater, a heat exchanger system for obtaining thermal energy from wastewater, and a method for manufacturing a heat exchanger module for obtaining thermal energy from wastewater.

Heat exchanger modules are employed in various systems to absorb thermal energy from an environment and to transmit it to a working fluid, so that the heated working fluid can be used in a further process, in particular for obtaining and transmitting heat. Here, two or more heat exchanger modules may be connected to form a heat exchanger system. The absorbed heat is often waste heat, which is a (by) product of upstream production, processing and in particular also household processes. This waste heat would otherwise not be used and would accordingly be lost. A heat exchanger system which can be used to transmit heat from wastewater to a working fluid is known from DE 10 2020 004 061 A1, for example.

FIG. 5 shows a heat exchanger system known from the prior art which is arranged in a wastewater pipe 90. The heat exchanger system comprises two heat exchanger modules 1 which are connected in parallel. Here, the supply lines 20a and the discharge lines 20b of the heat exchanger modules 1 are connected to each other, respectively. Each of the heat exchanger modules 1 comprises a heat exchanger element 10 which is connected to the supply line 20a via a supply port 21a and to the supply line 20b via a supply port 21b. Here, these are exclusively welding connections. The heat exchanger elements 10 each have first and second heat exchanger plates 12, 14 which are welded to each other. Inside the heat exchanger elements, a fluid running structure 18 is respectively formed, through which the working fluid can flow from the supply line 20a to the discharge line 20b.

A field of application of such heat exchanger modules is a wastewater system, for example, which is fed with wastewater from industrial facilities and/or private households. Here, an attempt is made to absorb at least part of the heat of the wastewater and to make it further usable with the aid of a heat exchanger module which is arranged in a wastewater pipe of the wastewater system. Here, the heat exchanger module is placed in the wastewater pipe so that the wastewater pipe flows around it.

Precisely in wastewater systems, the wastewater conveyed therein contains further solid objects which cannot be transported dissolved in the water. An example of such objects may be used feminine hygiene articles, diapers, fibrous substances, plants, plastics and other fabrics. If such, in particular flexible, objects flow around a heat exchanger module in the wastewater pipe, they may get caught on individual elements of the heat exchanger module and thus lead to a constriction and/or blockage of the wastewater pipe. Furthermore, objects getting caught or stuck on individual elements of the heat exchanger module may lead to increased resistance to the wastewater flowing around, which may impair the stability or structural integrity of the heat exchanger module and/or the efficiency of the heat exchanger module.

In particular in manufacturing a heat exchanger module, it has to be ensured that the individual elements of the heat exchanger module are connected to each other in a fluid-tight and in particular stable manner. This fluid-tight connection of the individual elements imposes requirements on the spatial design of the heat exchanger module, such as, for example, the arrangement of heat exchanger plates and supply and discharge lines. In manufacturing conventional heat exchanger modules, it has to be further ensured that all elements are connected in a fluid-tight manner and that a good flow of wastewater can be guaranteed, while at the same time reducing as much as possible the risk of an object, in particular a flexible one, which is transported with the wastewater, getting stuck on an element of the heat exchanger module.

Therefore, it is an object of the disclosure to propose a heat exchanger module and a method for manufacturing an improved heat exchanger module which in particular is stable, easy to manufacture and to mount, and also in which the risk of, in particular flexible, objects in the wastewater getting caught or stuck is reduced.

This object is solved by the subject-matter of the independent claims. Advantageous further developments are constituted by the subject-matter of the dependent claims.

One aspect relates to a heat exchanger module for obtaining thermal energy from wastewater, comprising a heat exchanger element which is configured to be inserted into a wastewater pipe and in which a working fluid can flow, and a fluid line for supplying or discharging the working fluid to or from the heat exchanger element, wherein the heat exchanger element and the fluid line are fluidically connectable to each other via a connection configuration, wherein the connection configuration comprises: a socket connected to the heat exchanger element, a through pipe connected to the fluid line and extending through a wall of the fluid line, and a screw element, wherein the socket comprises a socket thread and a socket pressing surface, the through pipe comprises an outwardly directed first through pipe pressing surface and an inwardly directed second through pipe pressing surface, and the screw element comprises a screw element thread and a screw element pressing surface, and the socket thread and the screw element thread are engageable with each other to screw the socket and the screw element to each other through the through pipe, so that the socket pressing surface is pressed onto the first through pipe pressing surface and the screw element pressing surface is pressed onto the second through pipe pressing surface to connect the heat exchanger element and the fluid line to each other in a fluid-tight manner.

By connecting the fluid line and the heat exchanger element, a simple and at the same time secure and stable fluid-tight connection can be enabled. As compared to other connections such as a direct welding connection of the fluid line and the heat exchanger element with a connection element, which requires a sufficiently large distance between the fluid line and the heat exchanger element and a sufficient accessibility of the welding regions, the distance between the fluid line and the heat exchanger element can be reduced. The socket may be attached to the heat exchanger element before the fluid line and the heat exchanger element are connected to each other via the connection configuration. Likewise, the through pipe may previously be arranged in and connected to the fluid line. In this way, the distance between the heat exchanger element and the fluid line can be reduced, since the individual elements are welded together before being connected.

Furthermore, the connection configuration may be arranged in both an edge region and a central region of the heat exchanger element, since connecting the socket and the screw element requires only accessibility of the screw element inside the fluid line. Thus, a comparatively compact heat exchanger module can be enabled and/or the freedom of design of the heat exchanger module can be increased.

Furthermore, this thus allows the heat exchanger element and the fluid line to be separated from each other by the connection configuration, in contrast to a traditional permanent connection such as a welding connection, for example. Thus, not only can laying into a wastewater pipe be facilitated, but also individual elements can be replaced, which can facilitate maintenance and/or repair.

The heat exchanger element is configured to be inserted into a wastewater pipe. Here, the heat exchanger element may be shaped so as to be adapted to a standardized wastewater pipe. In particular, the heat exchanger element may have a bent shape.

The heat exchanger element is formed such that a working fluid can flow therein. In other words, the heat exchanger element may be formed as a hollow body through which the working fluid can flow. Here, the heat exchanger element may comprise at least two heat exchanger plates that are connected, in particular connected by a material bond, preferably welded or soldered to each other. The heat exchanger plates may in particular be connected by means of laser welding. The heat exchanger element may have a volume and/or fluid running structure inside.

Here, one or more of the heat exchanger plates may have or be a metal plate, in particular have or be a metal sheet. In particular, one or more of the heat exchanger plates may have or be formed from iron, steel, stainless steel, aluminum, brass and/or copper.

The fluid line is in particular configured for supplying or discharging the working fluid to or from the heat exchanger element. In other words, the working fluid can be guided into or out of the inner space of the heat exchanger element via the fluid line.

Here, the fluid line may be formed as a pipe and/or hollow cylinder. In particular, the fluid line may have or be formed from metal, in particular iron, steel, stainless steel, aluminum, brass and/or copper.

The fluid line may have one or more ports through which the working fluid can be conveyed through the fluid line. In addition, the fluid line may be connectable to a further fluid line, in particular of a further heat exchanger module.

The working fluid may be a liquid, in particular water or a water mixture. In particular, the working fluid may have or be a water-glycol mixture. This allows that in the event of a leak, for example due to damage to one or more elements, the escaping working fluid does not endanger or deteriorate the water quality. In addition, it allows the working fluid to at least remain liquid even at low temperatures below the freezing point of water.

The heat exchanger element and the fluid line are fluidically connectable to each other via the connection configuration. Here, the connection configuration comprises the socket, the through pipe and the screw element. The through pipe comprises an outwardly directed first through pipe pressing surface.

Here, the term “outward(ly)” indicates a direction to an environment outside the fluid line, and the term “inward(ly)” indicates a direction to an inner space inside the fluid line through which the working fluid is guided through the fluid line. For example, the axial direction of the through pipe may approximately coincide with or be approximately parallel with a radial direction of the fluid line. The first through pipe pressing surface is arranged in particular outside the fluid line, and the second through pipe pressing surface is arranged in particular inside the fluid line.

Thus, the heat exchanger element and the fluid line may be fluidically connected to each other via the connection configuration such that the heat exchanger element with the socket is arranged outside the fluid line and the screw element is arranged inside the fluid line.

The socket may have or be formed from a metal, in particular iron, steel, stainless steel, aluminum, brass and/or copper.

The socket thread and the screw element thread are engageable with each other to screw the socket and the screw element to each other through the through pipe. By being screwed to each other, the socket pressing surface and the first through pipe pressing surface outside the fluid line can be pressed onto each other and the screw element pressing surface and the second through pipe pressing surface inside the fluid line can be pressed onto each other. Thereby, the heat exchanger element and the fluid line can be connected to each other in a fluid-tight manner. In other words, by being screwed to each other, a bias can be established which presses the socket pressing surface onto the first through pipe pressing surface and the screw element pressing surface onto the second through pipe pressing surface such that the fluid line and the heat exchanger element are connected to each other in a fluid-tight manner. In still other words, the through pipe can be clamped between the socket and the screw element. The threads may be provided with a sealing adhesive when being screwed to each other, which can further improve the tightness and durability of the connection.

Here, the socket pressing surface and the first through pipe pressing surface and/or the screw element pressing surface and the second through pipe pressing surface may be oriented substantially in parallel with each other. Here, the socket pressing surface and the first through pipe pressing surface and/or the screw element pressing surface and the second through pipe pressing surface may be substantially planar. This can allow good sealing with easy manufacture.

Alternatively, at least a respective one of the socket pressing surface and the first through pipe pressing surface and/or the screw element pressing surface and the second through pipe pressing surface may be formed to be conical, wherein the conical pressing surface is pressed against an inner edge of the other pressing surface. Thus, improved sealing can be achieved.

As an example, the socket may have a passage, the screw element may be formed as a hollow body, and the working fluid may flow through the passage of the socket and through the screw element between the heat exchanger element and the fluid line in the connected state of the socket and the screw element.

The socket may be connected to the heat exchanger element by a material bond, in particular by means of welding or soldering. Additionally or alternatively, the through pipe may be connected to the fluid line by a material bond, in particular by means of welding or soldering.

Thus, the heat exchanger element with the socket or the fluid line with the through pipe can be manufactured in an easy and automated manner. Here, the heat exchanger element and/or the fluid line may be prepared in automated, in particular separate, steps before being connected to each other in a fluid-tight manner. Here, a material bond connection allows fluid-tight supply and/or discharge of the working fluid to or from the heat exchanger element, wherein the connection is particularly durable. The through pipe may have an increased outer diameter portion which is adapted to the outer contour of the fluid line and thus rests on the fluid line substantially entirely, in particular around the recess of the fluid line provided therefor. This can facilitate the manufacture, since correct positioning or orientation of the through pipe with respect to the fluid line can easily be ensured during the connection process.

The material bond connection of the socket to the heat exchanger element and/or the through pipe to the fluid line may in particular be a laser welding connection. This can allow the individual elements to be connected to each other precisely and without necessary contact during welding.

Furthermore, the socket may be formed to be step-shaped with a step, the step may form the socket pressing surface, and the socket may have a socket insertion portion having a thread, in particular the socket thread, and having a reduced diameter, which is insertable into the through pipe. The socket may further have a socket attachment portion on the heat exchanger element side, wherein the diameter of the socket insertion portion is smaller than the diameter of the socket attachment portion, and wherein the socket pressing surface may be formed at the transition from the socket attachment portion to the socket insertion portion.

In particular, the socket may be formed to have a substantially hollow cylindrical shape and the socket insertion portion may have a reduced outer diameter.

Alternatively, the socket pressing surface may be an axial socket end surface facing away from the heat exchanger element. In other words, the socket may be formed without a step.

Thus, easy manufacture of the socket, in particular as a rotary component, can be enabled. Providing a socket insertion portion having a reduced diameter can further allow the socket to be easily arranged/positioned inside the through pipe to facilitate connection of the heat exchanger element and the fluid line. Furthermore, a secure connection of the socket and the screw element can thereby be enabled.

Furthermore, the screw element may have a screw element insertion portion having a thread, in particular the screw element thread, and a head portion. The screw element pressing surface may be formed at the transition from the screw element insertion portion to the head portion. In particular, a diameter of the screw element insertion portion is smaller than a diameter of the head portion. The screw element insertion portion may be insertable into the through pipe.

The head portion may further have a drive profile. In particular, the drive profile may be formed on an inner side or outer side of the head portion. Furthermore, the drive profile may have a multi-surface or polygonal shape, in particular a hexagonal shape.

In particular, the screw element may be formed to have a substantially hollow cylindrical shape and the screw element insertion portion may have a reduced outer diameter.

Thus, easy manufacture of the screw element, in particular as a rotary component, can be enabled. Providing a screw element insertion portion having a reduced diameter can further allow the socket to be easily arranged/positioned inside the through pipe to facilitate connection of the heat exchanger element and the fluid line. Furthermore, a secure connection of the socket and the screw element can thereby be enabled.

Furthermore, the through pipe may be formed to have a substantially hollow cylindrical shape, wherein an inner diameter of the through pipe may be greater than or equal to an (outer) diameter, in particular present at least in sections, of the socket insertion portion and/or the screw element insertion portion. The first and second through pipe pressing surfaces may be formed by the axial end surfaces of the through pipe.

In particular, the (outer) diameter of the socket insertion portion and/or the screw element insertion portion may be equal to or smaller than the inner diameter of the through pipe by up to 5 mm, preferably up to about 4 mm, more preferably up to about 3 mm, particularly preferably up to about 2 mm, more particularly preferably up to about 1 mm. In particular, the socket insertion portion may be arranged in the through pipe in a form-fit or force-fit manner.

Thus, arrangement/positioning of the socket and/or the screw element in the through pipe that is as easy as possible can be enabled.

Furthermore, the through pipe may be connected to the fluid line such that the through pipe extends in the radial direction of the fluid line through the wall. In other words, the through pipe may extend transversely to the axial direction of the fluid line.

Furthermore, an (outer) diameter of the socket pressing surface and/or the screw element pressing surface may substantially correspond to an outer diameter of the through pipe. Thus, a transition as even as possible can be achieved, wherein the risk of objects getting caught and/or stuck can be reduced in particular at the transition between the socket and the through pipe.

Furthermore, the socket may have an internal thread and the screw element may have an external thread. In other words, the socket thread may be formed as an internal thread and the screw element thread may be formed as an external thread.

As a result, the fluid line and the heat exchanger element can be easily connected to each other, wherein the individual elements of the connection configuration are protected particularly from damage when being connected. In particular, the socket (on which the heat exchanger element is arranged) having the internal thread can be allowed to be arranged inside the through pipe and thereafter, only the screw element has to be inserted into the through pipe, so that damage to the thread of the socket through the through pipe can be prevented.

Alternatively, the socket may have an external thread and the screw element may have an internal thread. In other words, the socket thread may be formed as an external thread and the screw element thread may be formed as an internal thread.

Furthermore, a seal element may be arrangeable between the socket pressing surface and the first through pipe pressing surface and/or between the screw element pressing surface and the second through pipe pressing surface, respectively. Here, the connection configuration may comprise the seal element. The seal element may in particular be formed as an O ring and/or as a sealant.

Here, providing a seal element may improve the tightness of the connection configuration and/or allow to achieve fluid tightness already at a low contact pressure between the pressing surfaces by the socket and the screw element being screwed to each other. Thus, the mechanical load on the individual components can be reduced.

Alternatively, a seal element may be omitted when the temperature and/or the (chemical) composition of wastewater or working fluid may adversely affect the structural integrity of a seal element, for example. Here, a fluid-tight connection configuration can be enabled by an increased contact pressure and is then also usable under corresponding conditions.

Furthermore, the one fluid line may be a supply line for supplying the working fluid to the heat exchanger element, the heat exchanger module may further have a discharge line for discharging the working fluid from the heat exchanger element, and the heat exchanger element and the discharge line may be fluidically connectable to each other via a further connection configuration. In other words, the heat exchanger module may have a further fluid line which may be a discharge line for discharging the working fluid from the heat exchanger element.

In other words, the further connection configuration may have a further socket connected to the heat exchanger element, and a further through pipe connected to the discharge line and extending through a wall of the discharge line, and a further screw element.

Here, the further socket may be configured like the socket, the further through pipe may be configured like the through pipe, and the further screw element may be configured like the screw element.

In other words, the further socket may have a socket thread and a socket pressing surface. The further through pipe may have an outwardly directed first through pipe pressing surface and an inwardly directed second through pipe pressing surface. The further screw element may have a screw element thread and a screw element pressing surface. The socket thread and the screw element thread may be engageable with each other to screw the further socket and the further screw element to each other through the further through pipe, so that the socket pressing surface is pressed onto the first through pipe pressing surface and the screw element pressing surface is pressed onto the second through pipe pressing surface to connect the heat exchanger element and the discharge line to each other in a fluid-tight manner.

Thus, it can be made possible to provide a configuration in which during both the supply and the discharge of the working fluid to and from the heat exchanger element, a fluid-tight connection that is as stable as possible and easy to manufacture can be provided, wherein the risk of objects in the wastewater getting stuck at the connection points of the heat exchanger element and the fluid lines is additionally reduced.

Furthermore, the first through pipe pressing surface and/or the second through pipe pressing surface may be formed as an end surface of the through pipe. The through pipe may in particular be formed to have a hollow cylindrical shape.

Alternatively, the first through pipe pressing surface and/or the second through pipe pressing surface may be formed as a step.

Thus, easy sealing at the first and/or second through pipe pressing surface can be enabled. Furthermore, the through pipe can be easily produced, in particular as a rotary component.

The through pipe may have or be formed from a metal, in particular iron, steel, stainless steel, aluminum, brass and/or copper.

The through pipe may have a diameter reduced towards the fluid line. For example, the fluid line may have a diameter of about 3 cm to about 15 cm, whereas the through pipe may have a diameter of about 0.5 cm to about 3 cm, for example. In particular, the cross-sectional area of the fluid line may be about 2 times, in particular about 3 times, in particular about 5 times, in particular about 10 times, in particular about 15 times, in particular about 20 times, greater than the cross-sectional area of the through pipe. Thus, a fluid line may conduct sufficient working fluid to sufficiently and effectively supply a heat exchanger system consisting of a plurality of heat exchanger modules.

Furthermore, a distance between the fluid line and the heat exchanger element in a fluid-tightly connected state may be smaller than about 2 cm, smaller than about 1.5 cm, smaller than about 1 cm, or smaller than about 0.5 cm.

By virtue of the reduced distance, in particular as compared to a heat exchanger module in which the heat exchanger element and the fluid line are connected to each other exclusively via welding connections, for example, the risk of objects transported with the wastewater getting stuck between the fluid line and the heat exchanger element can be reduced.

Furthermore, the connection configuration may be fluid-tight to at least about 10 bars, preferably about 15 bars, more preferably about 20 bars, particularly preferably about 25 bars, more particularly preferably about 40 bars.

In addition to obtaining thermal energy from wastewater, the heat exchanger module may also be used such that thermal energy from the working fluid is transferred to the wastewater, for example to prevent freezing of wastewater.

A further aspect relates to a heat exchanger system for obtaining thermal energy from wastewater, comprising two or more heat exchanger modules according to the above aspect, wherein the two or more heat exchanger modules are connectable in parallel and/or in series.

Two or more heat exchanger modules of the heat exchanger system may be connectable in parallel. In other words, the heat exchanger modules may each have a supply line and a discharge line and the heat exchanger system may have a system supply line to which the supply lines of the heat exchanger modules may be fluidically connectable. Alternatively, the supply lines may be connected to each other and form the system supply lines. Further, the heat exchanger system may have a system discharge line to which the discharge lines of the heat exchanger modules may be fluidically connectable.

Additionally or alternatively, two or more heat exchanger modules of the heat exchanger system may be connectable in series. In other words, the heat exchanger modules may each have a supply line and a discharge line, wherein a supply line of one heat exchanger module may be fluidically connectable to a discharge line of another heat exchanger module.

Depending on the design of a wastewater pipe in which the heat exchanger system is to be arranged, obtaining thermal energy from the wastewater can be enabled in the best possible manner, wherein the risk of objects transported in the wastewater getting stuck on elements of the heat exchanger system is reduced.

In addition to obtaining thermal energy from wastewater, the heat exchanger system may also be used such that thermal energy from the working fluid is transferred to the wastewater, for example to prevent freezing of wastewater.

A further aspect relates to a method for manufacturing a heat exchanger module for obtaining thermal energy from wastewater, comprising the steps of: providing a heat exchanger element which is configured to be inserted into a wastewater pipe and in which a working fluid can flow, wherein the heat exchanger element comprises a socket and the socket comprises a socket thread and a socket pressing surface, providing a fluid line for supplying or discharging the working fluid to or from the heat exchanger element, wherein the fluid line comprises a through pipe which extends through a wall of the fluid line, and wherein the through pipe comprises an outwardly directed first through pipe pressing surface and an inwardly directed second through pipe pressing surface, providing a screw element, wherein the screw element comprises a screw element thread and a screw element pressing surface and wherein the socket thread and the screw element thread are engageable with each other, and screwing the screw element and the socket to each other through the through pipe, so that the socket pressing surface is pressed onto the first through pipe pressing surface and the screw element pressing surface is pressed onto the second through pipe pressing surface to connect the heat exchanger element and the fluid line to each other in a fluid-tight manner.

The method may in particular be a method for manufacturing a heat exchanger module according to the above aspect. The heat exchanger module may in particular be designed according to the above aspect.

The heat exchanger module thus manufactured may have a fluid-tight connection of the fluid line and the heat exchanger element which is simple and at the same time secure and stable. As compared to other connections, such as a direct welding connection of the fluid line and the heat exchanger element with a connection element, which requires a sufficiently large distance between the fluid line and the heat exchanger element and a sufficient accessibility of the welding regions, the distance between the fluid line and the heat exchanger element can be reduced.

Furthermore, this thus allows the heat exchanger element and the fluid line to be separated from each other, in contrast to a permanent connection such as a welding connection, for example. Thus, not only can the laying into a wastewater pipe be facilitated, but also individual elements can be replaced, which can facilitate maintenance and/or repair.

The steps of the method may in particular be executed in the following order of 1), 2), 3) and 4):
1) Providing a heat exchanger element which is configured to be inserted into a wastewater pipe and in which a working fluid can flow, wherein the heat exchanger element comprises a socket and the socket comprises a socket thread and a socket pressing surface,
2) providing a fluid line for supplying or discharging the working fluid to or from the heat exchanger element, wherein the fluid line comprises a through pipe which extends through a wall of the fluid line, and wherein the through pipe comprises an outwardly directed first through pipe pressing surface and an inwardly directed second through pipe pressing surface,
3) providing a screw element, wherein the screw element comprises a screw element thread and a screw element pressing surface and wherein the socket thread and the screw element thread are engageable with each other, and
4) screwing the screw element and the socket to each other through the through pipe, so that the socket pressing surface is pressed onto the first through pipe pressing surface and the screw element pressing surface is pressed onto the second through pipe pressing surface to connect the heat exchanger element and the fluid line to each other in a fluid-tight manner.

The steps 1) and 2) may alternatively also be carried out simultaneously or in the order of 2) and 1).

Here, a step of manufacturing a connection configuration via which the heat exchanger element and the fluid line are fluidically connected to each other, may include the steps of providing the screw element and screwing the screw element and the socket to each other. In particular, the step of manufacturing a connection configuration may be executed as step 3.0) subsequent to steps 1) and 2).

Furthermore, providing the heat exchanger element may comprise:
providing at least two heat exchanger plates,
generating a, in particular circular, plate recess in one of the heat exchanger plates, and
attaching the socket to the one heat exchanger plate by a material bond such that the socket covers the plate recess and the working fluid can flow through the plate recess and the socket. Here, the steps may be executed as part of step 1) in the following order:
1.1) providing at least two heat exchanger plates,
1.2) generating a, in particular circular, plate recess in one of the heat exchanger plates, and
1.3) attaching the socket to the one heat exchanger plate by a material bond such that the socket covers the plate recess and the working fluid can flow through the plate recess and the socket. Here, one or more of the heat exchanger plates may have or be a metal plate, in particular have or be a metal sheet. In particular, one or more of the heat exchanger plates may have or be formed from iron, steel, stainless steel, aluminum, brass and/or copper.

Generating the, in particular circular, plate recess may be carried out mechanically, in particular by drilling, punching, milling or cutting, or thermally, in particular by burning, melting or lasering.

Attaching the socket to the one heat exchanger plate by a material bond may be carried out such that the socket covers the plate recess and the working fluid can flow through the plate recess. In other words, the socket may have a passage and be attached to the one heat exchanger plate by a material bond such that the working fluid can flow through the plate recess and the passage of the socket. The socket may be attached to the one heat exchanger plate with a surface opposite the socket pressing surface.

Attaching by a material bond may be carried out in particular by means of welding, preferably laser welding, or soldering. This can allow the individual elements to be connected to each other precisely and in particular without necessary contact when being attached.

If the plate recess is made by lasering and attaching the socket is carried out by laser welding, these two steps may also be carried out easily in a single production step, wherein precise arrangement and good sealing can be enabled in the best way possible.

Attaching by a material bond may also be carried out in an automated manner.

Furthermore, providing the heat exchanger element may further comprise:
connecting the heat exchanger plates by a material bond, in particular by means of welding or soldering, according to a predetermined connection structure, and
deforming, in particular hydroforming, the heat exchanger plates connected by a material bond by fluid pressurization through the socket to shape a volume and/or fluid running structure inside the heat exchanger element.

Here, the steps may be executed as part of step 1) in the following order:
1.4) connecting the heat exchanger plates by a material bond, in particular by means of welding or soldering, according to a predetermined connection structure, and
1.5) deforming, in particular hydroforming, the heat exchanger plates connected by a material bond by fluid pressurization through the socket to shape a volume and/or fluid running structure inside the heat exchanger element.

Here, step 1.4) may be carried out subsequently to or in parallel with step 1.3).

Connecting the heat exchanger plates by a material bond may be carried out in particular by means of laser welding. If attaching the socket to the one heat exchanger plate is also carried out by means of welding, in particular laser welding, the steps can be carried out in one production step easily, precisely and in particular without necessary contact when being welded to each other.

Connecting the heat exchanger plates by a material bond may be carried out according to a predetermined connection structure. Here, the connection structure may have a point structure and/or a line structure. Here, the point structure and/or the line structure may require the volume and/or fluid running structure of the heat exchanger element.

Connecting by a material bond may also be carried out in an automated manner. Thus, both attaching the socket and connecting the heat exchanger plates may be carried out easily in a single automated production step.

Deforming the heat exchanger plates connected by a material bond may be carried out by fluid pressurization through the socket. In other words, pressurized fluid may be guided through the socket into the inside of the heat exchanger element such that the heat exchanger plates deform.

Here, the heat exchanger plates may be connected permanently or temporarily before deformation in the edge regions. In particular, the connection structure may require the heat exchanger plates, in particular in the edge regions, to be connected in a manner fluid-tight to the outside.

If the connection structure requires the edge regions to be connected, the heat exchanger module may be prepared for deformation in a single production step, in particular in an automated manner.

Deforming the heat exchanger plates through the socket may allow the heat exchanger plates to be deformed directly after being connected to each other and being connected to the socket, even before the heat exchanger element is connected to the fluid line. Thus, the heat exchanger plates can be deformed in an easy and secure manner. Further, a fluid pressure line for deformation can easily be joined to the socket, which enables easy and secure deformation. Also, the deformed heat exchanger element can be checked for tightness and/or correct shape before being connected to the fluid line.

Furthermore, providing the fluid line may comprise:
providing a fluid line blank,
generating a, in particular circular, line recess in the wall of the fluid line blank, and
attaching the through pipe in the line recess by a material bond, in particular by means of welding or soldering, such that the through pipe extends through the wall of the fluid line and the working fluid can flow through the through pipe.

Here, the steps may be executed as part of step 2) in the following order:
2.1) providing a fluid line blank,
2.2) generating a, in particular circular, line recess in the wall of the fluid line blank, and
2.3) attaching the through pipe in the line recess by a material bond, in particular by means of welding or soldering, such that the through pipe extends through the wall of the fluid line and the working fluid can flow through the through pipe.

Generating the, in particular circular, line recess may be carried out mechanically, in particular by drilling, punching, milling or cutting, or thermally, in particular by burning, melting or lasering.

Attaching the through pipe in the line recess by a material bond may be carried out such that the through pipe extends through the wall of the fluid line and the working fluid can flow through the through pipe. However, the working fluid does not have to be able to flow directly through the through pipe, but may also flow through the screw element and the socket which may be connected through the through pipe. In other words, the through pipe may have a passage and be attached to the one heat exchanger plate by a material bond such that the socket and the screw element are connectable through the through pipe.

Attaching by a material bond may be carried out in particular by means of welding, preferably laser welding, or soldering. This can allow the individual elements to be connected to each other precisely and in particular without necessary contact when being welded.

Furthermore, by screwing the screw element and the socket to each other, the socket pressing surface may be pressed onto the first through pipe pressing surface in such a way that it rests entirely on the first through pipe pressing surface in a fluid-tight manner. Additionally or alternatively, by screwing the screw element and the socket to each other, the screw element pressing surface may be pressed onto the second through pipe pressing surface in such a way that it rests entirely on the second through pipe pressing surface in a fluid-tight manner.

Thus, a fluid-tight and compact connection of the heat exchanger element and the fluid line can be established in an easy manner.

Furthermore, the method may include a step of arranging a thread sealant on the socket thread and/or the screw element thread, in particular as step 4.0) prior to step 4). Here, the thread sealant may have or be an organic material such as hemp, for example, a synthetic material such as Teflon, for example, and/or a, in particular curing, liquid seal such as a thread locker, for example.

In the following, embodiments of the present disclosure will be described in more detail on the basis of the appended figures. It is to be understood that the present disclosure is not limited to these embodiments, and that individual features of the embodiments may be freely combined to create further embodiments.

### BRIEF DESCRIPTION OF THE DRAWINGS

FIG. 1 shows a section of a heat exchanger module in a connected state.

FIG. 2 shows the section of the heat exchanger module of FIG. 1 in a non-connected state.

FIG. 3 shows a partial sectional view of the heat exchanger module of FIG. 2 in another non-connected state with a partial sectional view.

FIG. 4 shows a perspective view of the heat exchanger module of FIG. 3 in a non-connected state.

FIG. 5 shows a heat exchanger system known from the prior art.

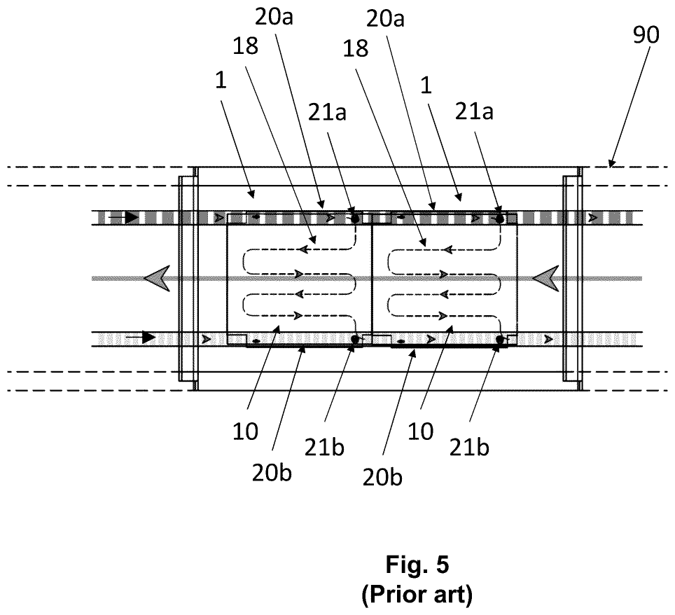

### DETAILED DESCRIPTION OF PREFERRED EMBODIMENTS

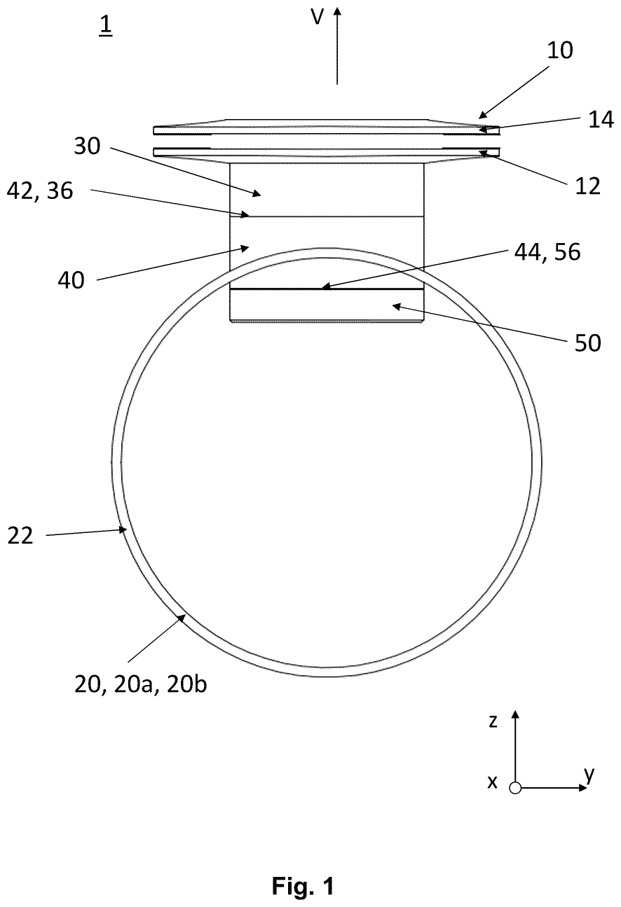

FIG. 1 shows a heat exchanger module 1 with a fluid line 20 with a through pipe 40 welded thereto, through which a screw element 50 and a socket 30 are screwed to each other. The socket 30 is welded to a first heat exchanger plate 12 of a heat exchanger element 10.

The through pipe 40 extends through a wall 22 of the fluid line in a connection direction V. The connection direction V corresponds to a radial direction of the fluid line 20 and is a direction along which the socket 30 and the screw element 50 can be connected through the through pipe 40 and into which a working fluid can flow from the fluid line into the heat exchanger element 10. The fluid line 20 may be a supply line 20a or discharge line 20b. In the figures, the connection direction V corresponds to the direction of the z axis. The connection direction V runs perpendicular to an axial direction of the fluid line F which corresponds to the direction of the x axis in the figures.

Inside the fluid line 20, the screw element 50 is arranged on a side of the through pipe 40 opposite to the connection direction V and in a manner abutting against a second through pipe pressing surface 44 of the through pipe 40. The screw element 50 is screwed to the socket 30 such that a screw element pressing surface 56 is pressed against the second through pipe pressing surface 44.

Outside the fluid line 20, the heat exchanger element 10 with the socket 30 is arranged such that a socket pressing surface 36 of the socket 30 abuts against a first through pipe pressing surface 42 of the through pipe 40. By screwing the socket 30 and the screw element 50 to each other, the socket pressing surface 36 is pressed onto the first through pipe pressing surface 42.

Thus, the fluid line 20 and the heat exchanger element 10 are fluidically connected to each other via a connection configuration. By the contact pressure, the connection configuration is fluid-tight to the outside. Here, both the socket pressing surface 36 and the first through pipe pressing surface 42 and the screw element pressing surface 56 and the second through pipe pressing surface 44 may be pressed onto each other so as to abut against one another in a fluid-tight manner. For effective sealing, however, it may be sufficient that only the socket pressing surface 36 and the first through pipe pressing surface 42 be pressed onto each other in a fluid-tight manner.

In addition to the first heat exchanger plate 12, the heat exchanger element 10 comprises a second heat exchanger plate 14 which is spaced apart from the first heat exchanger plate 12 in the connection direction V. The illustration of the heat exchanger element 10 shows only some sections and is schematic. A material bond connection of the first and second heat exchanger plates 12, 14, in particular at the edge regions thereof (not shown), is not shown in the figures.

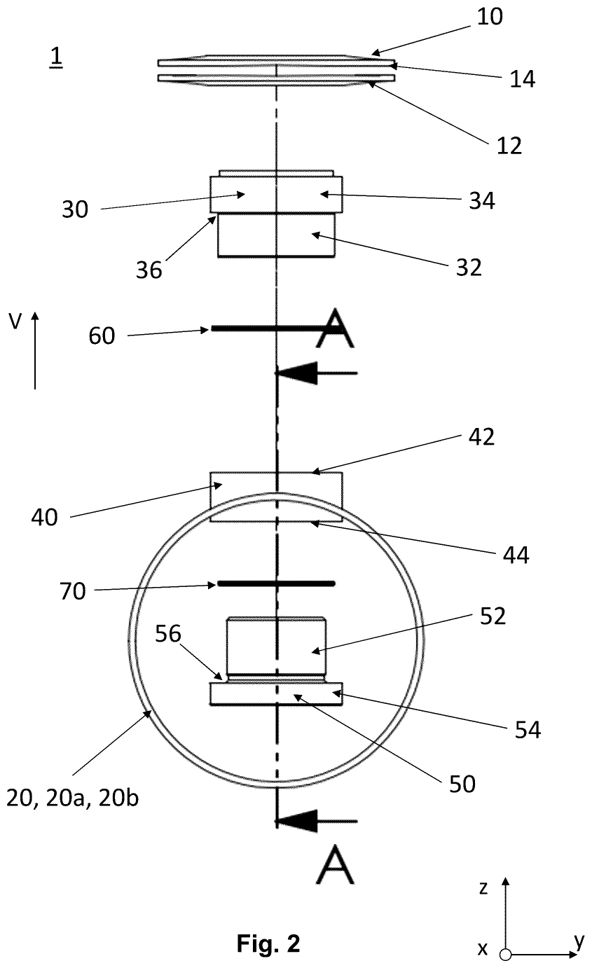

FIG. 2 shows the heat exchanger module 1 of FIG. 1 in a non-connected state. The screw element 50 is arranged inside the fluid line 20 and in a manner spaced apart from the through pipe 40 opposite to the connection direction V. Between the screw element 50 and the through pipe 40, a second sealing element 70 which is formed as an O ring is arranged. In a connected state, the second sealing element 70 is arranged in sections between the second through pipe pressing surface 44 and the screw element pressing surface 56 and may cause improved sealing, wherein the necessary contact pressure can be reduced. Here, the second through pipe pressing surface 44 and/or the screw element pressing surface 56 may have a groove in which the second sealing element 70 may be arranged at least in sections.

The screw element 50 comprises a head portion 54 and a screw element insertion portion 52, wherein the outer diameter of the screw element insertion portion 52 is smaller than the outer diameter of the head portion 54. The screw element pressing surface 56 is formed as a step at the transition from the head portion 54 to the screw element insertion portion 52. In the connected state, the screw element insertion portion 52 is arranged inside the through pipe 40. The screw element insertion portion 52 comprises an external thread (not shown).

The socket 30 is arranged outside the fluid line 20 in a state not connected to the heat exchanger element 10. It is spaced apart from the through pipe 40 in the connection direction V. Between the socket 30 and the through pipe 40, a first sealing element 60 which is formed as an O ring is arranged. In a connected state, the first sealing element 60 is arranged in sections between the first through pipe pressing surface 42 and the socket pressing surface 36 and may cause improved sealing, wherein the necessary contact pressure can be reduced. Here, the first through pipe pressing surface 42 and/or the socket pressing surface 36 may have a groove in which the first sealing element 60 may be arranged at least in sections.

The socket comprises a socket attachment portion 34 and a socket insertion portion 32, wherein the outer diameter of the socket insertion portion 32 is smaller than the outer diameter of the socket attachment portion 34. The socket pressing surface 36 is formed as a step at the transition from the socket attachment portion 34 to the socket insertion portion 32. In the connected state, the socket insertion portion 32 is arranged inside the through pipe 40. The socket insertion portion 32 comprises an internal thread (not shown). The socket 30 and the screw element 50 may be engaged with and screw to each other via the internal thread and the external thread to press the socket pressing surface 36 onto the first through pipe pressing surface 42 and the screw element pressing surface 56 onto the second through pipe pressing surface 44.

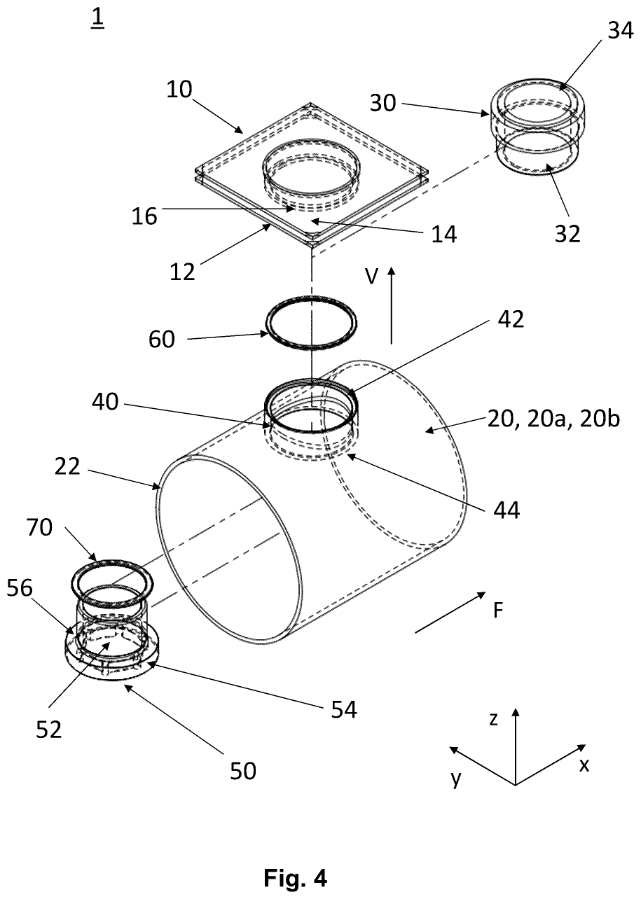

The socket 30 is attachable to the first heat exchanger plate 12 of the heat exchanger element 10 which is arranged spaced part from the socket 30 in the connection direction V with the socket attachment portion 34. At the socket attachment portion 34, the socket comprises a positioning protrusion which is insertable into a plate recess 16 of the first heat exchanger plate 12 (shown in FIG. 4). This can facilitate correct positioning of the socket 30 for attachment to the heat exchanger element 10.

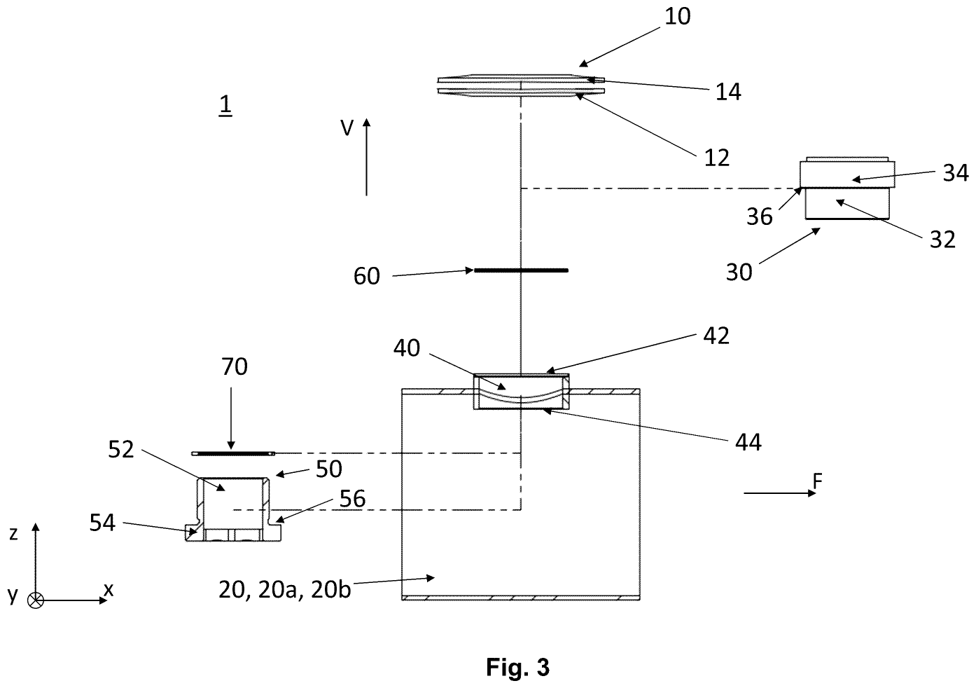

FIG. 3 shows the heat exchanger element 1 of FIG. 2 in another non-connected state, wherein the fluid line 20 with the through pipe 40, the second sealing element 70 and the screw element 50 are shown in section (along the A-A sectional line of FIG. 2).

The screw element 50 is formed to have a hollow cylindrical shape, so that in the state connected to the socket 30, working fluid can flow from the fluid line 20 through the screw element 50 and through the socket 30 into the heat exchanger element 10 (or in the reverse direction). The screw element 50 further comprises a drive profile, formed to be internally hexagonal, on an inner surface in the head portion 54.

The through pipe 40 is formed to have a hollow cylindrical shape and the first through pipe pressing surface 42 and the second through pipe pressing surface 44 are formed as end surfaces of the through pipe 40. The inner diameter of the through pipe 40 corresponds approximately to the outer diameter of the socket insertion portion 32.

In order to manufacture the heat exchanger module 1, the socket 30 may first be attached to the first heat exchanger plate 12 by a material bond, in particular by means of laser welding. Here, previously, simultaneously or subsequently, the first heat exchanger plate 12 and the second heat exchanger plate 14 may be connected by a material bond, in particular by means of laser welding. Subsequently, a fluid in a pressurized form may be guided into the heat exchanger element 10 via the socket 30 to deform it.

In order to screw the socket 30 and the screw element 50 to each other, the socket 30 may be arranged in the through pipe 40 opposite to the connection direction V with the socket insertion portion 32. By virtue of the reduced outer diameter of the socket insertion portion 32, which corresponds approximately to the inner diameter of the through pipe 40, the socket 30 can be easily positioned. Here, between the socket pressing surface 36 and the first through pipe pressing surface 42, the first sealing element 60 is arranged.

Subsequently, the screw element 50 is inserted into the fluid line 20 through an opening of the fluid line 20 in (or opposite to) the axial direction F and screwed to the socket 30 in the connection direction V through the through pipe 40. Here, between the screw element pressing surface 56 and the second through pipe pressing surface 44, the second sealing element 70 is arranged.

Prior to screwing, a thread sealant (not shown) may be attached to the internal thread and/or the external thread. In this way, improved and secure sealing can further be enabled.

For screwing, a suitable tool may be applied to the drive profile of the screw element 50 through an opening of the fluid line 20.

FIG. 4 shows a perspective view of the heat exchanger module 1 of FIG. 3 in a non-connected state.

The individual elements of the heat exchanger module 1 are shown to be transparent, wherein covered lines and edges are shown as dashed lines.

The first heat exchanger plate 12 comprises a plate recess 16 which is formed to be circular. In order to attach the socket 30 to the first heat exchanger plate 12, the socket is arranged on the heat exchanger plate 12 with the socket attachment portion 34 such that the socket 30 completely covers the plate recess 16. Here, positioning can be facilitated by the positioning protrusion of the socket 30. Here, the diameter of the plate recess 16 is smaller than the outer diameter of the socket attachment portion 34. In particular, the diameter of the plate recess 16 may substantially correspond to the outer diameter of the positioning protrusion.

1. A heat exchanger module for obtaining thermal energy from wastewater, comprising:
a heat exchanger element which is configured to be inserted into a wastewater pipe and in which a working fluid can flow; and
a fluid line for supplying or discharging the working fluid to or from the heat exchanger element,
wherein the heat exchanger element and the fluid line are fluidically connectable to each other via a connection configuration, wherein the connection configuration comprises:
a socket connected to the heat exchanger element;
a through pipe connected to the fluid line and extending through a wall of the fluid line; and
a screw element; wherein
the socket comprises a socket thread and a socket pressing surface,
the through pipe comprises an outwardly directed first through pipe pressing surface and an inwardly directed second through pipe pressing surface,
and the screw element comprises a screw element thread and a screw element pressing surface, and
the socket thread and the screw element thread are engageable with each other to screw the socket and the screw element to each other through the through pipe, so that the socket pressing surface is pressed onto the first through pipe pressing surface and the screw element pressing surface is pressed onto the second through pipe pressing surface to connect the heat exchanger element and the fluid line to each other in a fluid-tight manner.

2. The heat exchanger module according to claim 1,
wherein the socket is connected to the heat exchanger element by a material bond, in particular by means of welding or soldering, and/or
wherein the through pipe is connected to the fluid line by a material bond, in particular by means of welding or soldering.

3. The heat exchanger module according to claim 1, wherein
the socket is formed to be step-shaped with a step,
the step forms the socket pressing surface, and
the socket comprises a socket insertion portion, having a thread and having a reduced diameter, which is insertable into the through pipe.

4. The heat exchanger module according to claim 1,
wherein the screw element comprises a screw element insertion portion having a thread and a head portion, and
wherein at the transition from the screw element insertion portion to the head portion, the screw element pressing surface is formed.

5. The heat exchanger module according to claim 1, wherein the socket comprises an internal thread and the screw element comprises an external thread.

6. The heat exchanger module according to claim 1, wherein between the socket pressing surface and the first through pipe pressing surface and/or between the screw element pressing surface and the second through pipe pressing surface, a seal element is arrangeable, respectively.

7. The heat exchanger module according to claim 1, wherein
the one fluid line is a supply line for supplying the working fluid to the heat exchanger element,
the heat exchanger module further comprises a discharge line for discharging the working fluid from the heat exchanger element, and
wherein the heat exchanger element and the discharge line are fluidically connectable to each other via a further connection configuration.

8. The heat exchanger module according to claim 1, wherein the first through pipe pressing surface and/or the second through pipe pressing surface is formed as an end surface of the through pipe.

9. The heat exchanger module according to claim 1, wherein a distance between the fluid line and the heat exchanger element in a fluid-tightly connected state is smaller than about 2 cm, smaller than about 1.5 cm, smaller than about 1 cm or smaller than about 0.5 cm.

10. A heat exchanger system for obtaining thermal energy from wastewater, comprising two or more heat exchanger modules according to claim 1, wherein the two or more heat exchanger modules are connectable in parallel and/or in series.

11. A method for manufacturing a heat exchanger module for obtaining thermal energy from wastewater, comprising the steps of:
providing a heat exchanger element which is configured to be inserted into a wastewater pipe and in which a working fluid can flow, wherein the heat exchanger element comprises a socket and the socket comprises a socket thread and a socket pressing surface;
providing a fluid line for supplying or discharging the working fluid to or from the heat exchanger element, wherein the fluid line comprises a through pipe which extends through a wall of the fluid line, and wherein the through pipe comprises an outwardly directed first through pipe pressing surface and an inwardly directed second through pipe pressing surface;
providing a screw element, wherein the screw element comprises a screw element thread and a screw element pressing surface and wherein the socket thread and the screw element thread are engageable with each other; and
screwing the screw element and the socket to each other through the through pipe, so that the socket pressing surface is pressed onto the first through pipe pressing surface and the screw element pressing surface is pressed onto the second through pipe pressing surface to connect the heat exchanger element and the fluid line to each other in a fluid-tight manner.

12. The method according to claim 11, wherein providing the heat exchanger element comprises:
providing at least two heat exchanger plates;
generating a, in particular circular, plate recess in one of the heat exchanger plates; and
attaching the socket to the one heat exchanger plate by a material bond such that the socket covers the plate recess and the working fluid can flow through the plate recess and the socket.

13. The method according to claim 12, wherein providing the heat exchanger element further comprises:
connecting the heat exchanger plates by a material bond, in particular by means of welding or soldering, according to a predetermined connection structure; and
deforming the heat exchanger plates connected by a material bond by fluid pressurization through the socket to shape a volume and/or fluid running structure inside the heat exchanger element.

14. The method according to claim 11, wherein providing the fluid line comprises:
providing a fluid line blank;
generating a, in particular circular, line recess in the wall of the fluid line blank; and
attaching the through pipe in the line recess by a material bond, in particular by means of welding or soldering, such that the through pipe extends through the wall of the fluid line and the working fluid can flow through the through pipe.

15. The method according to claim 11, wherein by screwing the screw element and the socket to each other,
the socket pressing surface is pressed onto the first through pipe pressing surface in such a way that it rests entirely on the first through pipe pressing surface in a fluid-tight manner, and/or
the screw element pressing surface is pressed onto the second through pipe pressing surface in such a way that it rests entirely on the second through pipe pressing surface in a fluid-tight manner.
